(19) United States
(12) Patent Application Publication
(10) Pub. No.: US 2009/0110855 A1
(43) Pub. Date: Apr. 30, 2009

(54) Filled Polystyrene Compositions and Uses Thereof

(75) Inventors: Donald C. McCarthy, Appleton, WI (US); William Pucci, Winneconne, WI (US); Anthony J. Swiontek, Neenah, WI (US)

Correspondence Address: PATENT GROUP GA030-43;GEORGIA-PACIFIC LLC, 133 PEACHTREE STREET, N.E., ATLANTA, GA, 30303-1847, US

(73) Assignee: Dixie Consumer Products LLC, Atlanta, GA (US)

(21) Appl. No.: 11/928,280

(22) Filed: Oct. 30, 2007

(51) Int. Cl. B32B 27/08; B29C 47/04; B32B 9/00

(52) U.S. Cl. 428/35.7; 264/211.24; 428/339

(57) ABSTRACT

The present invention provides polymer formulations containing 20 to about 40 weight percent of a filler, such as calcium carbonate. Multilayer polymer structures containing a filler in at least one layer of the multilayer structure, and methods of making these multilayer structures, are also disclosed. Articles of manufacture, such as food service articles, including cups, lids, plates, trays, containers, cutlery, and the like, derived from these formulations and multilayer structures are also provided in the present invention.

### BACKGROUND OF THE INVENTION

The present invention relates generally to polymer formulations containing a filler, and in particular, to multilayer polymer structures containing a filler in at least one layer of the multilayer structure. Articles of manufacture, such as food service articles, derived from such formulations and structures are also provided in the present invention. These food service articles can include cups, lids, plates, trays, containers, cutlery, and the like, which are produced in varied polymer processing operations including, for example, injection molding, sheet extrusion, and thermoforming.

Reducing the cost of polymer formulations, structures, and end-use articles is continually desired, but not easily achieved. The performance properties of the end-use article generally must be maintained to ensure fitness for use in the desired application. Such properties can include the strength, durability, flexibility, stiffness, impact resistance, and crack resistance of the article. Simply reducing gauge or thickness (i.e., downgauging) usually adversely impacts one or more physical properties to the detriment of the downgauged article, as compared to what is expected of the current product in the marketplace and by the consumer.

One method to reduce cost is to add an inexpensive filler, such as calcium carbonate, with a cost lower than that of the polymer, to a polymer formulation. Essentially, one displaces a more expensive polymer component with a less expensive filler component at a loading, for example, of 20% or more in the polymer formulation or the overall structure.

For some polymers, the addition of a filler such as calcium carbonate can improve certain physical properties of the polymer article. In others, such as polystyrene, the addition of a filler is generally disadvantageous for the strength properties of the polymer article, as discussed in U.S. Pat. No. 4,101,050, the disclosure of which is incorporated herein by reference in its entirety.

Additionally, fillers suitable for use in the present invention have a density greater than that of the base polymer resin, such as polystyrene. Therefore, increasing filler content at the expense of the polymer resin content decreases yield, i.e., less end-use articles can be produced from a given weight of the filled polymer formulation. Furthermore, part weight increases, especially for articles produced in large quantities, can dramatically increase other downstream costs, such as shipping and freight costs.

Hence, in order to maintain the yield or the part weight to within about 10-15% of that of the original unfilled polymer article, attempts to downgauge or reduce sheet or wall thickness are often employed. For formulations with polystyrene, such a strategy can further deteriorate the end-use properties of the filled article to a level that is unacceptable for that product in the marketplace.

Attempts to improve the properties of both filled and unfilled polystyrene formulations using blends with other polymers, such as conventional polyolefins (e.g., low density polyethylene), are also problematic. Manufacturing processes involving the fabrication of polymers into desired end-use articles generally reclaim waste, trim, start-up scrap, or other similar material in order to maintain economic feasibility. Hence, the use of dissimilar polymers in an attempt to improve the properties of a polystyrene formulation can lead to problems in reclaiming and reusing such waste material.

Thus, to this point, it has been commercially impractical to produce filled polystyrene materials for certain end-use applications with 20% or greater filler content, while the filled article is thinner in gauge than the current unfilled article, yet with the same or improved physical properties. Certain filled polystyrene formulations and structures have been discussed in the prior art and are known to the skilled artisan, but these disclosures have failed to address the needs or solve the problems noted above, nor provide any specific guidance in this regard. Accordingly, it is to these ends that the present invention is directed.

### BRIEF SUMMARY OF THE INVENTION

The present invention discloses novel multilayer polymer structures and methods of making such structures. These multilayer polymer structures comprise from 20 to about 40 weight percent of the at least one filler. Such structures can be used to produce a variety of articles of manufacture, such as food services articles, including cups, lids, plates, trays, containers, and cutlery.

Multilayer polymer structures in accordance with the present invention comprise a core layer having a first side and a second side, the core layer comprising at least one filler; an inner layer positioned on the first side of the core layer; and an outer layer positioned on the second side of the core layer. Each of the core layer, the inner layer, and the outer layer, independently, comprise at least one high impact polystyrene (HIPS) polymer. The at least one HIPS polymer has an elastomeric material content of at least about 7 percent by weight, an average particle size of the elastomeric material from about 1 to about 10 microns, and a mineral oil content of less than about 4 percent by weight. Additionally, the at least one HIPS polymer is characterized by a melt flow rate of less than about 12 and a flexural modulus from about 200,000 to about 400,000 psi.

These multilayer polymer structures have a unique and unexpected combination of stiffness/rigidity properties and strength/impact properties. These structures solve an unmet need in the marketplace by allowing an unfilled polystyrene-based product or article to be replaced with a filled structure having 20% or more of at least one filler, such as calcium carbonate. The resulting filled product can be thinner in gauge than the incumbent unfilled structure, yet have the desired attributes of superior toughness combined with comparable or superior rigidity or stiffness.

The present invention also provides a method of making a multilayer polymer structure, wherein the multilayer polymer structure comprises from 20 to about 40 weight percent of at least one filler having a density of greater than about 2 g/cc. One such method comprises providing a core layer, an inner layer, and an outer layer, and coextruding the core layer between the inner layer and the outer layer to produce the multilayer polymer structure. In this aspect, the core layer comprises at least one high impact polystyrene (HIPS) polymer and from about 25 to about 50 weight percent of the at least one filler. Each of the inner layer and the outer layer, independently, also comprise at least one HIPS polymer. The at least one HIPS polymer has an elastomeric material content of at least about 7 percent by weight, an average particle size of the elastomeric material from about 1 to about 10 microns, and a mineral oil content of less than about 4 percent by weight. The at least one HIPS polymer is further characterized by a melt flow rate of less than about 12 and a flexural modulus from about 200,000 to about 400,000 psi.

Although this method specifies coextrusion as the process to produce a multilayer polymer structure, the present invention is not so limited. Multilayer structures of this invention can formed by any process known to affix similar or dissimilar polymer layers together, including combinations of two or more different processes. Additionally, further steps can be employed to convert the multilayer polymer structure into a finished article of manufacture, such as, for example, the process of thermoforming.

Various articles of manufacture can be produced from the compositions and multilayer polymer structures of the present invention, including food service articles, such as cups, lids, plates, trays, containers, cutlery, and the like. In one aspect of the present invention, a multilayer food service article comprising 20 to about 40 weight percent of at least one filler is provided. This multilayer food service article comprises a core layer having a first side and a second side, the core layer comprising at least one filler; an inner layer adjacent to the first side of the core layer; and an outer layer adjacent to the second side of the core layer. Each of the core layer, the inner layer, and the outer layer, independently, comprise at least one HIPS polymer. This HIPS polymer has an elastomeric material content of at least about 7 percent by weight, an average particle size of the elastomeric material from about 1 to about 10 microns, and a mineral oil content of less than about 4 percent by weight. The at least one HIPS polymer is characterized further by having a melt flow rate of less than about 12 and a flexural modulus from about 200,000 to about 400,000 psi.

According to another aspect of the present invention, a multilayer cup is provided. This cup comprises a core layer having a first side and a second side, the core layer comprising calcium carbonate; an inner layer adjacent to the first side of the core layer; an outer layer adjacent to the second side of the core layer; and a cap layer adjacent to the outer layer, the cap layer comprising crystal polystyrene. Each of the core layer, the inner layer, and the outer layer, independently, comprise at least one HIPS polymer. The at least one HIPS polymer has an elastomeric material content from about 7 percent to about 10.5 percent by weight, an average particle size of the elastomeric material from about 2 to about 8 microns, and a mineral oil content of less than about 4 percent by weight. The at least one HIPS polymer is characterized by a melt flow rate of less than about 3.6 and a flexural modulus from about 225,000 to about 325,000 psi. It is contemplated that this multilayer cup contains from 20 to about 40 weight percent of calcium carbonate, from about 4 to about 9 weight percent of elastomeric material, and less than 5 weight percent crystal polystyrene.

In another aspect, a masterbatch composition is provided. A masterbatch can be described generally as a composition or formulation containing a high loading or concentration of an additive or filler in a carrier resin. The masterbatch composition is subsequently let down in, and blended with, another polymer at a certain percentage to give the final weight percent of the filler or additive desired in the formulation. The present invention discloses a novel masterbatch composition comprising from about 50 to about 85 weight percent of at least one filler. Such a masterbatch composition comprises at least one HIPS polymer and the at least one filler. Generally, the HIPS polymer has an elastomeric material content of at least about 7 percent by weight, an average particle size of the elastomeric material from about 1 to about 10 microns, and a mineral oil content of less than about 4 percent by weight. Further, the at least one HIPS polymer is characterized by a melt flow rate of less than about 12 and a flexural modulus from about 200,000 to about 400,000 psi.

A single layer polymer structure, or one or more layers in a multilayer polymer structure, can comprise these masterbatch compositions. One such example is a single layer in a multilayer polymer structure, where the single layer comprises a masterbatch composition containing about 70 to about 75 weight percent calcium carbonate, as the filler, and at least one HIPS polymer with characteristics as described above.

### BRIEF DESCRIPTION OF THE FIGURES

FIG. 1 presents an illustration of a 3-layer multilayer polymer structure according to one aspect of the present invention.

FIG. 2 presents an illustration of a 4-layer multilayer polymer structure according to one aspect of the present invention.

FIG. 3 presents an illustration of a 5-layer multilayer polymer structure according to one aspect of the present invention.

FIG. 4 presents an illustration of a 7-layer multilayer polymer structure according to one aspect of the present invention.

FIG. 5 presents a plot of the tensile strength at yield (psi) versus weight percent of calcium carbonate for filled polystyrene formulations containing Resin A, Resin C, and Resin D.

FIG. 6 presents a plot of the tensile strength at break (psi) versus weight percent of calcium carbonate for filled polystyrene formulations containing Resin A, Resin C, and Resin D.

FIG. 7 presents a plot of the notched Izod impact strength (ft-lbs/in) versus weight percent of calcium carbonate for filled polystyrene formulations containing Resin A, Resin C, and Resin D.

FIG. 8 presents a plot of the unnotched Izod impact strength (ft-lbs/in) versus weight percent of calcium carbonate for filled polystyrene formulations containing Resin A, Resin C, and Resin D.

FIG. 9 presents a plot of the elongation at break (%) versus weight percent of calcium carbonate for filled polystyrene formulations containing Resin A, Resin C, and Resin D.

FIG. 10 presents a plot of the elongation at yield (%) versus weight percent of calcium carbonate for filled polystyrene formulations containing Resin A, Resin C, and Resin D.

FIG. 11 presents a plot of the flexural modulus (psi) versus weight percent of calcium carbonate for filled polystyrene formulations containing Resin A, Resin C, and Resin D.

### DETAILED DESCRIPTION OF THE INVENTION

The present invention discloses novel multilayer polymer structures and methods of making such structures. These multilayer polymer structures comprise from 20 to about 40 weight percent of at least one filler. Multilayer polymer structures in accordance with the present invention comprise:

(a) a core layer having a first side and a second side, the core layer comprising at least one filler;

(b) an inner layer positioned on the first side of the core layer; and

(c) an outer layer positioned on the second side of the core layer;

wherein:

each of the core layer, the inner layer, and the outer layer, independently, comprise at least one high impact polystyrene (HIPS) polymer,

wherein the at least one HIPS polymer has an elastomeric material content of at least about 7 percent by weight, an average particle size of the elastomeric material from about 1 to about 10 microns, a mineral oil content of less than about 4 percent by weight, and

wherein the at least one HIPS polymer is characterized by a melt flow rate of less than about 12 and a flexural modulus from about 200,000 to about 400,000 psi.

Applicants disclose several types of ranges in the present invention. These include, but are not limited to, a range of weight percent of filler in a multilayer polymer structure, a range of weight percent of elastomeric material in a HIPS polymer, a range of average particle size of the elastomeric material, a range of mineral oil content in a HIPS polymer, a range of melt flow rate of a HIPS polymer, a range of flexural modulus of a HIPS polymer, and a range of weight percent of crystal polystyrene in a multilayer polymer structure. When Applicants disclose or claim a range of any type, Applicants' intent is to disclose or claim individually each possible number that such a range could reasonably encompass, as well as any sub-ranges and combinations of sub-ranges encompassed therein. For example, by a disclosure that the weight percent of at least one filler in the multilayer polymer structure is from 20 to about 40 weight percent, Applicants intend to recite that the weight percent can be selected from 20, about 21, about 22, about 23, about 24, about 25, about 26, about 27, about 28, about 29, about 30, about 31, about 32, about 33, about 34, about 35, about 36, about 37, about 38, about 39, or about 40. Additionally, the weight percent of the at least one filler can be within any range from 20 to about 40 (for example, the weight percent is in a range from about 22 to about 38 percent), and this also includes any combination of ranges between 20 and about 40 (for example, 20 to about 25 percent and about 30 to about 35 percent). Likewise, all other ranges disclosed herein should be interpreted in a manner similar to this example.

Applicants reserve the right to proviso out or exclude any individual members of any such range, including any sub-ranges or combinations of sub-ranges within the stated range, that can be claimed according to a range or in any similar manner, if for any reason Applicants choose to claim less than the full measure of the disclosure, for example, to account for a reference that Applicants may be unaware of at the time of the filing of the application.

While compositions, formulations, polymer structures, articles, and methods are described in terms of comprising various components or steps, these compositions, formulations, polymer structures, articles, and methods can also “consist essentially of” or “consist of” the various components or steps.

### Polystyrene Polymers

The present invention utilizes polymers of vinyl aromatic compounds which have been modified with an elastomeric material. One such vinyl aromatic polymer suitable for use in the present invention is polystyrene (PS). Polystyrene which has been modified with an elastomeric material is often referred to as rubber-modified polystyrene or high impact polystyrene (HIPS). Generally, HIPS comprises a polystyrene polymer having discrete particles of an elastomeric material dispersed throughout the styrene polymer matrix.

HIPS materials are generally obtained by polymerizing, or copolymerizing, the vinyl aromatic monomer (e.g., styrene) in the presence of the elastomer material. Polymerizing in the presence of the elastomeric material generally results in a superior product to blended products (e.g., equivalent impact strength at lower elastomer incorporation), but blended products and other means of incorporating the elastomeric material into the polystyrene (PS) polymer can be employed. Thus, HIPS polymers manufactured in accordance with any conventional process known to those of skill in the art can be used in the present invention.

An elastomeric material can be a natural or synthetic rubber or any elastomeric material that acts as a toughening agent when dispersed in a polymer matrix. Suitable elastomeric polymers for modifying vinyl aromatic polymers such as polystyrene generally have a glass transition temperature, Tg, less than zero and often less than −20° C. Examples of suitable elastomeric polymers include, but are not limited to, homopolymers of C₄-C₆ 1,3-dienes (e.g., polybutadiene, polyisoprene), copolymers of one or more vinyl aromatic monomers and one or more C₄-C₆ 1,3-dienes (e.g., styrene-butadiene copolymers), copolymers of ethylene and propylene (e.g., ethylene-propylene rubber or EPR), terpolymers of ethylene, propylene, and a diene (e.g., EPDM rubber), and the like, or combinations thereof. In other aspects of this invention, the elastomeric material is selected from a polybutadiene, a polyisobutylene, a polybutene, a polyisoprene, a styrene-butadiene copolymer, or a mixture or combination of one or more of these materials.

Numerous HIPS polymer grades are readily available from several PS resin suppliers and are often selected based on the requirements of the end-use application and the mode of processing (sheet extrusion, injection molding, etc.) to be employed. Table I lists several polystyrene resin grades that will be discussed throughout this disclosure. Table I also includes nominal or data sheet properties for each respective HIPS polymer resin grade. These resin grades are commercially available from Chevron Phillips Chemical Company, Dow Chemical Company, and Total Petrochemicals.

Polybutadiene and polyisobutylene are the predominant elastomeric materials in the commercial grades listed in Table I. For instance, Resins C, G, H, and I contain both of these elastomeric materials. Resin E, however, contains polybutadiene but does not contain polyisobutylene. Resins C and I contain higher levels of cis-polybutadiene than trans-polybutadiene, while the opposite is true for Resins E, F, G, and H. Generally, HIPS grades with higher cis-polybutadiene content, as compared to trans, have superior environmental stress crack resistance (ESCR) and are more flexible at the same elastomeric content in the HIPS resin.

As noted above, a HIPS polymer comprises a polystyrene matrix having dispersed therein particles of an elastomeric material. The average particle size of the elastomeric material in the HIPS polymer can be controlled during the manufacture of the HIPS polymer. HIPS polymers having average particle sizes of the elastomeric material in the range from about 1 to about 10 microns are useful in the present invention. Further, the average particle size can be from about 2 to about 8 microns in another aspect of this invention. In yet another aspect, the average particle size of the elastomeric material in the HIPS polymer is from about 2 to about 4 microns. In accordance with a different aspect of the present invention, the average particle size of the elastomeric material is from about 6 to about 8 microns. The average particle size of the elastomeric material can be determined by any means known to those of skill in the art, such as from particle size distribution curves determined via commercially available particle size analyzers.

It has been discovered that the weight percent of the elastomeric material in the HIPS polymer should be at least about 7 percent for the multilayer polymer structures to have the unique properties disclosed herein. In another aspect, the HIPS polymer has an elastomeric material content in a range from about 7 percent to about 15 percent by weight. Alternatively, the percent of the elastomeric material in the HIPS polymer can be from about 8 percent to about 13 percent, or from about 8 percent to about 11 percent, by weight, in other aspects of this invention. Yet, in still another aspect of the present invention, the weight percent of the elastomeric material is in a range from about 7 percent to about 10.5 percent. In a further aspect, the weight percent of the elastomeric material in the HIPS polymer is from about 8 percent to about 10.5 percent.

In this invention, the HIPS polymer has a lubricant or mineral oil content of less than about 4 percent by weight. In another aspect, the lubricant or mineral oil content is less than about 2 percent by weight. Yet, in another aspect, the HIPS polymer resin contains substantially no added lubricant or mineral oil (e.g., less than 0.5 percent).

Generally, polystyrene polymers—whether crystal PS or HIPS—have superior strength properties at higher molecular weights. Melt flow rate is inversely related to molecular weight and, therefore, polystyrene polymers having a lower melt flow rate typically have superior strength properties. In addition to affecting the strength properties of the resulting polystyrene article or product, the melt flow rate of the polystyrene polymer is often selected based on the mode of fabrication employed, such as injection molding versus sheet extrusion, to ensure good processability in the respective mode of fabrication. In balancing these strength and processability considerations, the HIPS polymer employed in the multilayer polymer structures of this invention should have a melt flow rate of less than about 12. Melt flow rate data has units of g/10 min, and is measured at 20000 using a 5-Kg weight in accordance with ASTM D1238. In other aspects of the present invention, the melt flow rate is less than about 10, less than about 8, or less than about 5. In a further aspect, the melt flow rate of the HIPS polymer is less than about 3.6. In a different aspect, the melt flow rate of the HIPS polymer is in a range from about 2.8 to about 3.5.

It is further contemplated that HIPS polymers having a flexural modulus from about 200,000 to about 400,000 psi can be employed in this invention. Flexural modulus is one measure of the stiffness or rigidity of an article, and is expressed in units of psi and is determined in accordance with ASTM D790. In another aspect of the present invention, a HIPS polymer having a flexural modulus in a range from about 225,000 to about 350,000 psi can be used. Further, the flexural modulus can be in a range from about 275,000 to about 325,000 psi, or from about 225,000 to about 250,000 psi, in other aspects of the invention. In a different aspect, a HIPS polymer having a flexural modulus in a range from about 225,000 to about 325,000 psi can be used in the present invention.

Another measure of stiffness or rigidity is tensile modulus. Tensile modulus is determined using ASTM D638 and has units of psi. HIPS polymers having a tensile modulus from about 175,000 to about 350,000 psi are within the scope of the present invention. In another aspect, a HIPS polymer having a tensile modulus in a range from about 190,000 to about 310,000 psi can be used. The tensile modulus can be in a range from about 290,000 to about 310,000 psi, or from about 190,000 to about 250,000 psi, in other aspects of the invention.

In one aspect of this invention, the modulus or stiffness of a formulation containing a PS or HIPS grade with at least one filler should increase, generally, in a linear fashion with the weight percentage of the at least one filler in the formulation. Thus, in this aspect, an increase in flexural modulus or tensile modulus with filler loading allows the polymer structure to be downgauged while maintaining the same rigidity as that of the thicker unfilled polymer structure. Such a feature is demonstrated, for instance, in FIG. 11 in Example 1 that follows.

In addition to HIPS polymer resin grades, other polystyrene grades can be employed in certain aspects of this invention. Crystal PS, often referred to as general purpose PS, is a polystyrene polymer which has not been modified with an elastomeric material. Articles produced from crystal PS generally have excellent clarity and stiffness, i.e., a high flexural modulus or flex modulus. HIPS polymers, as compared to crystal PS, are opaque and generally have superior impact strength, flexibility, and some grades have superior environmental stress crack resistance (ESCR).

TABLE I
Polystyrene resins and properties.

| Properties | Resin A | Resin B | Resin C | Resin D | Resin E | Resin F | Resin G | Resin H | Resin I |
|---|---|---|---|---|---|---|---|---|---|
| Melt Flow | 4 | 13 | 3.8 | 2.8 | 3.5 | 3.0 | 3.2 | 3.2 | 3.0 |
| (g/10 min.) | | | | | | | | | |
| Tensile | 340,000 | 320,000 | 230,000 | 250,000 | 300,000 | 300,000 | 240,000 | 250,000 | 191,000 |
| Modulus | | | | | | | | | |
| (psi) | | | | | | | | | |
| Flexural | 370,000 | 300,000 | 240,000 | 240,000 | 310,000 | 290,000 | 225,000 | 225,000 | 232,000 |
| Modulus | | | | | | | | | |
| (psi) | | | | | | | | | |
| Flexural | 8,300 | 5,700 | 5,000 | 5,800 | 6,300 | 5,600 | 4,200 | 4,500 | 5,400 |
| Strength | | | | | | | | | |
| (psi) | | | | | | | | | |
| Elastomeric | 5.5 | 6.0 | 11 | 8.5 | 8.0 | 8.5 | 9.5-10.0 | 9.5-10.0 | 9.0-10.5 |
| Material | | | | | | | | | |
| Content | | | | | | | | | |
| (%) | | | | | | | | | |
| Particle Size of | 2.7 | 2.3 | 6.8 | 7.2 | 2.5 | 2.1 | 6.8 | 6.8 | 6.0-8.0 |
| Elastomeric | | | | | | | | | |
| Material | | | | | | | | | |
| (microns) | | | | | | | | | |
| Notched Izod | 1.9 | 2.1 | 2.9 | 2.3 | 3.0 | 2.4 | 2.7 | 2.7 | 2.6 |
| (ft-lbs/in) | | | | | | | | | |
| Mineral Oil | 1.75 | 6.25 | 2.0 | 2.75 | 4.0 | 3.0 | 1.0 | 0 | 0.2 |
| Content | | | | | | | | | |
| (%) | | | | | | | | | |
| Elongation at | 45 | 45 | 65 | 55 | 55 | 65 | 85 | 65 | 62 |
| Break | | | | | | | | | |
| (%) | | | | | | | | | |

### Fillers

At least one filler is employed in the structures and formulations of the present invention. Suitable fillers include, but are not limited to, calcium carbonate, calcium sulphate, magnesium carbonate, magnesium hydroxide, silica, alumina, aluminum oxide, aluminum trihydrate, antimony oxide, talc, mica, clays (e.g., kaolin), fly ash, cellulosic fibers, glass fibers, glass flakes, glass spheres, and the like, or combinations thereof. The filler material can be coated with a compatibilizer, surfactant, or other substance to improve the compatibility with and/or dispersibility within the polymer matrix. These fillers can be supplied in the form of a masterbatch, which typically contains a high loading of the desired filler in a polymer carrier resin which is let down in the polymer structure at a certain percentage to give the final weight percent of the filler required. In one aspect of the present invention, and illustrated in the examples that follow, the at least one filler is calcium carbonate. Other fillers can be used in addition to calcium carbonate in the inventive multilayer polymer structures.

The weight percent of the at least one filler in the multilayer polymer structures contemplated by the present invention ranges from 20 to about 40 weight percent. The at least one filler can be calcium carbonate. In another aspect, the weight percent of filler is in a range from 20 to about 35 percent, or from 20 to about 30 percent. Yet, in another aspect, the weight percent of the at least one filler in the multilayer polymer structure is in a range from about 21 to about 39 percent, about 22 to about 38 percent, or about 25 to about 35 percent.

### Miscellaneous Additives

Additives are often used in polymer structures and formulations to improve the processing or ease of manufacturing of the polymer and its intended finished article. Another use of additives is to impart a certain property or characteristic to the finished article. In the present invention, additives which can be employed with the structure and formulations disclosed herein include, but are not limited to, antimicrobials, antioxidants, antistatic agents, colorants, heat stabilizers, light stabilizers, mold release agents, and the like. Colorant additives include the spectrum of pigments, dyes, and the like, that provide a desired color to a polymer structure and finished article, for example, a red colorant. These colorants also include such materials as carbon black (black) and titanium dioxide (white). A single additive, or a combination of several additives, can be used in the formulations and polymer structures of this invention. Additionally, although not a requirement in the present invention, a foaming or blowing agent additive optionally can be employed in one or more layers of the multilayer polymer structure.

### Masterbatch Composition

Generally, a masterbatch is a composition or formulation containing a high loading or concentration of an additive or filler in a carrier resin. The masterbatch composition is let down in, and blended with, another polymer at a certain percentage to give the final weight percent of the filler or additive desired in the formulation.

The present invention discloses a novel masterbatch composition comprising from about 50 to about 85 weight percent of at least one filler. In this aspect, a HIPS polymer is the carrier resin. Such a masterbatch composition comprises:

(a) at least one high impact polystyrene (HIPS) polymer; and

(b) at least one filler;

wherein:

the at least one HIPS polymer has an elastomeric material content of at least about 7 percent by weight, an average particle size of the elastomeric material from about 1 to about 10 microns, a mineral oil content of less than about 4 percent by weight, and the at least one HIPS polymer is characterized by a melt flow rate of less than about 12 and a flexural modulus from about 200,000 to about 400,000 psi.

In another aspect, the weight percent of the at least one filler in the masterbatch composition is in a range from about 60 to about 85 percent. Yet, in another aspect, the weight percent of the at least one filler in the masterbatch composition is in a range from about 70 to about 80 percent.

In these and other aspects of the present invention, the at least one filler in the masterbatch can be calcium carbonate. Alternatively, in lieu of the at least one filler, the masterbatch composition can contain at least one additive, and for example, the at least one additive can be titanium dioxide.

A single layer polymer structure, or one or more layers in a multilayer polymer structure, can comprise these masterbatch compositions. For example, a single layer polymer structure can be formed which comprises, for example, a masterbatch composition containing about 70% to about 85% calcium carbonate, by weight, and at least one HIPS polymer. Such a formulation can also be used in one or more layers of a multilayer polymer structure.

### Multilayer Polymer Structures

The present invention discloses novel multilayer polymer structures and methods of making such structures. These multilayer polymer structures comprise from 20 to about 40 weight percent of the at least one filler. Multilayer polymer structures in accordance with the present invention comprise:

(a) a core layer having a first side and a second side, the core layer comprising at least one filler;

(b) an inner layer positioned on the first side of the core layer; and

(c) an outer layer positioned on the second side of the core layer;

wherein:

each of the core layer, the inner layer, and the outer layer, independently, comprise at least one high impact polystyrene (HIPS) polymer,

wherein the at least one HIPS polymer has an elastomeric material content of at least about 7 percent by weight, an average particle size of the elastomeric material from about 1 to about 10 microns, a mineral oil content of less than about 4 percent by weight, and

wherein the at least one HIPS polymer is characterized by a melt flow rate of less than about 12 and a flexural modulus from about 200,000 to about 400,000 psi.

In other aspects of this invention, the multilayer polymer structure can have more than the three layers identified above as the core layer, the inner layer, and the outer layer. The core layer is not limited only to a middle layer in between two other layers. Rather, the core layer indicates only that it is an internal layer, and not an external or cap layer. The inner layer and the outer layer are described as being positioned on a first and a second side, respectively, of the core layer. An additional layer, or layers, can be between the core layer and the inner layer, and likewise, between the core layer and the outer layer. The inner and outer layers can be external layers or they can be internal layers which are surrounded by other internal layers or by an external or cap layer.

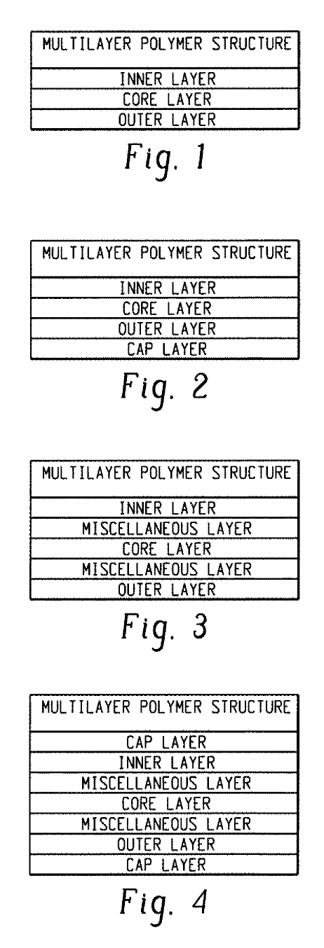

Various combinations of layers can be employed in the formation of the multilayer polymer structures of this invention. FIGS. 1-4, respectively, illustrate representative 3-layer, 4-layer, 5-layer, and 7-layer structures. These and other non-limiting layer configurations follow below, in which letters are used to represent the film layers: I/C/o, I/M/C/O, I/C/O/E, E/I/C/O, E/I/C/O/E, E/M/I/C/O, E/I/M/C/O, I/M/M/C/O, I/M/C/M/O, I/M/C/O/E, I/M/M/C/O, E/I/M/C/M/O, I/M/C/M/O/E, E/I/M/C/M/O/E, I/M/M/C/O/M/E, and E/I/M/M/C/M/O. In these examples, “C” represents a core layer, “I” represents an inner layer, “O” represents an outer layer, “E” represents an external or cap layer, and “M” represent a miscellaneous or other layer. Layers which are next to each other are described as being affixed to or adjacent to each other. For instance, in the multilayer structure I/M/C/O/E, the “O” layer is adjacent to or affixed to the second side of the “C” layer, and the “O” layer is also positioned on the second side of the “C” layer. Likewise, the “I” layer is not adjacent to or affixed to the first side of the “C” layer, but is positioned on the first side of the “C” layer. Hence, by referring to a given layer as positioned on one side of the core layer, the given layer can be adjacent to or affixed to the core layer, or an additional layer or layers (for example, “M”) can be between the given layer and the core layer. There is no upper limit on the total number of layers in a multilayer polymer structure that can utilize this invention, for instance, 7-layer and 9-layer structures, provided that the inner layer, core layer, and outer layer are present somewhere within the multilayer structure.

In addition to HIPS, crystal PS can be used in the multilayer polymer structures of the present invention. Crystal PS, however, can embrittle the multilayer polymer structure. Therefore, the multilayer polymer structure disclosed herein should contain less than 10% crystal PS by weight. In another aspect, such polymer structures have less than about 8%, or less than about 6%, crystal PS by weight. In yet another aspect, the weight percent of crystal PS in the multilayer polymer structure is less than about 5% to reduce the brittleness of the multilayer polymer structure. Still further, the weight percent of crystal PS is less than about 4%, or less than about 3%, of the multilayer polymer structure in other aspects of this invention. Additionally, in yet another aspect, the weight percent of crystal PS in the multilayer polymer structure is less than about 2%.

Crystal PS offers high gloss and has utility as an external or cap layer in a multilayer polymer structure for that reason. Hence, in one aspect of the present invention, the multilayer polymer structure comprising an inner layer, a core layer, and an outer layer can further comprise a cap layer adjacent to the outer layer, wherein the cap layer comprises crystal PS. In this aspect, the weight percent of crystal PS in the multilayer polymer structure is less than about 5%. According to another aspect of the present invention, the weight percent of crystal PS in the multilayer structure is less than about 3%, or less than about 2%.

As noted above, the weight percent of the elastomeric material in the HIPS polymer is at least about 7 percent. The resultant weight percent of the elastomeric material in the multilayer polymer structure generally falls within a range from about 4 to about 12 percent. Weight percents of the elastomeric material in the multilayer polymer structure ranging from about 4 to about 11 percent, or from about 4 to about 10 percent, can be employed in other aspects of this invention. Further, the weight percent of the elastomeric material in the multilayer polymer structure is in a range from about 4 to about 9 percent in another aspect of the present invention.

According to yet another aspect of this invention, substantially no additional elastomeric material (e.g., less than 0.5%) is present in the multilayer polymer structure other than the elastomeric material of the HIPS polymer. That is, substantially no additional elastomeric material needs to be added to the structures disclosed herein, such as via a masterbatch or by adding elastomeric polymer resin, to garner the unique properties and features of this invention.

In another aspect, the multilayer polymers structures of the present invention are substantially free (e.g., having less than 0.5% by weight) of conventional non-elastomeric polyolefins, such as disclosed in, for example, U.S. Pat. No. 4,111,349, the disclosure of which is incorporated herein by reference in its entirety. One of skill in the art would recognize that polyolefins exist which have elastomeric properties and could serve as the elastomeric material in the HIPS polymer. Conventional non-elastomeric polyolefins, conversely, can be added to improve properties of a multilayer polymer structure containing HIPS, but are not needed. Such dissimilar materials can negatively impact the extrusion process by depositing on the screw over time, thereby reducing flight depths and extrusion efficiency. Thus, in a further aspect, the multilayer polymer structures of the present invention contain no conventional non-elastomeric polyolefins.

Examples of conventional non-elastomeric polyolefins include, but are not limited to, polyethylene homopolymer (e.g., low density or high density polyethylene), polypropylene homopolymer, polybutene, ethylene/alpha-olefin copolymer (e.g., linear low density polyethylene or LLDPE, where the alpha-olefin is butene, hexene, or octene), propylene/alpha-olefin copolymer, butene/aIpha-olefin copolymer, ethylene/unsaturated ester copolymer, ethylene/unsaturated acid copolymer, (e.g., ethyl acrylate copolymer, ethylene/methyl acrylate copolymer, ethylene/acrylic acid copolymer, ethylene/methacrylic acid copolymer), ionomer resins, and the like. As noted above, a skilled artisan would realize that certain grades of these polymer resins can be designed to be elastomeric and thus are suitable as the impact modifier or toughening agent (i.e., the elastomeric material) in a HIPS polymer.

Generally, the core layer of a multilayer polymer structure comprises at least one high impact polystyrene polymer and from about 25 to about 50 weight percent of at least one filler having a density of greater than about 2 g/cc. Calcium carbonate is an example of a filler that is useful in the present invention, having a density of around 2.8 g/cc. In another aspect, the weight percent of the at least one filler, for example, calcium carbonate, is from about 25 to about 40 weight percent of the core layer, or from about 25 to about 35 weight percent of the core layer.

In one aspect of this invention, the core layer containing the at least one filler has a thickness that is from about 40 percent to about 80 percent of the total thickness of the multilayer polymer structure. If additional layers are employed to include the at least one filler, such as layer(s) “M” above, then the total thickness of these layers is from about 40 to a bout 80 percent of the total thickness of the multilayer polymer structure. In another aspect, the thickness of the core layer is from about 45 to about 75 percent, or from about 55 to a bout 70 percent, of the total thickness of the multilayer polymer structure.

In addition to at least one HIPS polymer and at least one filler, the core layer can contain regrind. Regrind is a general term to describe reclaimed and reused waste, trim, start-up scrap, or other similar material produced in the manufacturing of polymers and their conversion to finished articles. In many cases, the regrind material will have the composition of the multilayer polymer structure itself. Other layers, such as the inner layer, outer layer, or miscellaneous layer can also utilize regrind.

Both the inner and outer layers of the multilayer polymer structure comprise at least one HIPS polymer. In another aspect, the inner layer further comprises titanium dioxide. In a different aspect, the inner layer further comprises both titanium dioxide and at least one filler. In this aspect, calcium carbonate can be the at least one filler. In yet another aspect, the outer layer can further comprise a red colorant. This red colorant can be a red pigment or a red dye, or a combination thereof. In a different aspect, the outer layer further comprises both a red colorant and at least one filler. In this aspect, the at least one filler is calcium carbonate.

Finished articles or articles of manufacture, such as food service articles, can be produced from the multilayer polymers structures of the present invention, and will be discussed further below.

The present invention also provides a method of making a multilayer polymer structure. One such method comprises:

(a) providing a core layer, an inner layer, and an outer layer,

wherein:

the core layer comprises at least one high impact polystyrene polymer and from about 25 to about 50 weight percent of at least one filler having a density of greater than about 2 g/cc;

each of the inner layer and the outer layer, independently, comprise at least one high impact polystyrene (HIPS) polymer,

wherein the at least one HIPS polymer has an elastomeric material content of at least about 7 percent by weight, an average particle size of the elastomeric material from about 1 to about 10 microns, a mineral oil content of less than about 4 percent by weight, and

wherein the at least one HIPS polymer is characterized by a melt flow rate of less than about 12 and a flexural modulus from about 200,000 to about 400,000 psi; and

(b) coextruding the core layer between the inner layer and the outer layer to produce the multilayer polymer structure,

wherein the multilayer polymer structure comprises from 20 to about 40 weight percent of the at least one filler.

The process directly above provides one method of making a multilayer polymer structure via coextrusion. The multilayer structures of this invention can be formed by coextrusion, lamination, coating, or any other process known to affix similar or dissimilar polymer layers together, including combination of different processes. For instance, coextrusion can utilize tie layers or adhesive layers to improve the adherence of layers. Laminations can utilize heat and pressure to adhere layers together. Extrusion lamination and adhesive laminations are also contemplated. Additional layers can be added by extrusion coating, for example, or by any type of water or solvent-based polymer coating, in which the diluent is subsequently removed by drying, evaporation, or similar process,

Further to this method, an additional step is contemplated to form the multilayer polymer structure into an article of manufacture, such as a food service article, using a technique such as thermoforming.

### Articles

Compositions and multilayer structures of the present invention can be used to produce various articles of manufacture. Food service articles include cups, lids, plates, trays, containers, cutlery, and the like. Other examples of a food service article are a bowl, glass, box, pitcher, bottle, bucket, dish, platter, vase, cover, cap, top, sheet, closure, pan, sleeve, or case. Cutlery articles include such utensils as a fork, knife, or spoon.

Those of skill in the art would recognize that these articles of manufacture can be formed using various processes including, but not limited to, injection molding, blow molding, and sheet extrusion, the latter optionally followed by thermoforming to achieve the desired shape of the article.

In one aspect of the present invention, a multilayer food service article comprising 20 to about 40 weight percent of at least one filler is provided. This multilayer food service article comprises:

(a) a core layer having a first side and a second side, the core layer comprising at least one filler;

(b) an inner layer adjacent to the first side of the core layer; and

(c) an outer layer adjacent to the second side of the core layer;

wherein:

each of the core layer, the inner layer, and the outer layer, independently, comprise at least one high impact polystyrene (HIPS) polymer,

wherein the at least one HIPS polymer has an elastomeric material content of at least about 7 percent by weight, an average particle size of the elastomeric material from about 1 to about 10 microns, a mineral oil content of less than about 4 percent by weight, and

wherein the at least one HIPS polymer is characterized by a melt flow rate of less than about 12 and a flexural modulus from about 200,000 to about 400,000 psi.

In one aspect, this multilayer food service article is a cup, bowl, plate, or lid. Yet, in another aspect, the multilayer food service article is a multilayer cup. Key attributes for multilayer cups include rigidity and crack resistance, which are often measured and quantified using physical property testing such as flexural or tensile modulus, elongation, impact strength, brim resistance, bottom resistance, etc.

According to another aspect of the present invention, a multilayer cup is provided. This multilayer cup comprises:

(a) a core layer having a first side and a second side, the core layer comprising calcium carbonate;

(b) an inner layer adjacent to the first side of the core layer;

(c) an outer layer adjacent to the second side of the core layer;

(d) a cap layer adjacent to the outer layer, the cap layer comprising crystal polystyrene;

wherein:

each of the core layer, the inner layer, and the outer layer, independently, comprise at least one high impact polystyrene (HIPS) polymer,

the at least one HIPS polymer has an elastomeric material content from about 7 percent to about 10.5 percent by weight, an average particle size of the elastomeric material from about 2 to about 8 microns, a mineral oil content of less than about 4 percent by weight;

the at least one HIPS polymer is characterized by a melt flow rate of less than about 3.6 and a flexural modulus from about 225,000 to about 325,000 psi; and

the multilayer cup comprises from 20 to about 40 weight percent of calcium carbonate, from about 4 to about 9 weight percent of elastomeric material, and less than 5 weight percent crystal polystyrene.

### EXAMPLES

The invention is further illustrated by the following examples, which are not to be construed in any way as imposing limitations to the scope of this invention. Various other aspects, embodiments, modifications, and equivalents thereof which, after reading the description herein, may suggest themselves to one or ordinary skill in the art without departing from the spirit of the present invention or the scope of the appended claims.

Both the data presented in Table 1 and the physical property testing of the examples that follow were performed in accordance with the following analytical test procedures:

| | | |
|---|---|---|
| Melt Flow Rate | ASTM D1238 | g/10 min. |
| Specific Gravity | ASTM D792 | g/cc |
| Notched Izod Impact | ASTM D256 | ft-lbs/in |
| Unnotched Izod lmpact | ASTM D256 | ft-lbs/in |
| Tensile Strength @ Yield | ASTM D638 | psi |
| Tensile Strength @ Break | ASTM D638 | psi |
| Elongation @ Yield | ASTM D638 | % |
| Elongation @ Break | ASTM D638 | % |
| Tensile Modulus | ASTM D638 | psi |
| Flexural Modulus | ASTM D790 | psi |
| Flexural Strength | ASTM D790 | psi |
| Taber Stiffness | TAPPI T-489 | g-cm |

For polystyrene polymers, the melt flow rate is determined at 200° C. using a 5-Kg weight. Many physical properties tests, such as for tensile properties, are conducted in the machine (MD) and well as the transverse or cross direction (CD). Total energy absorbed (TEA) is a measure of the toughness of a sample and is equal to the area under the stress-strain curve of a tensile test, such as performed in accordance with ASTM D638. In addition to flexural modulus and tensile modulus, Taber stiffness can also be used to ascertain the rigidity of a polymer structure.

Article specific tests, such as for the comparison of multilayer cups, include the dry rigidity test, brim resistance test, bottom resistance test, crack resistance test, brim crush energy test, and sidewall crush energy test. The dry rigidity test is an instrumented test that determines the rigidity of an empty cup in pounds of force (lb·f) by compressing the sidewall of a cup 0.25 inches at a position on the cup that is two-thirds of the cup height.

Both high impact and low impact tests correlate with cup performance. For examples, high impact tests can be used to predict survivability in shipping and distribution and failures due to dropping. Low impact tests are more related to actual end-use performance, such as a consumer squeezing the cup sidewalls when drinking. In general, reducing the brittleness of the cup reduces the amount of breakage/scrap generated in the cup production process. Brittle cups can break when coming out of the mold or when squeezed during conveying or packaging.

Brim resistance is a high impact test that uses a pendulum to determine the energy required to damage the brim of the cup (e.g., a crease or a crack) to simulate damage to the cup that might occur during shipping or distribution. The test is conducted by placing a single test cup in an upright position against a solid wall. A standard weight (3.59 lb) is held at a 10° initial angle. The weight is released in a quick motion so that it strikes the brim of the cup. The swing angle is increased at 5 degree intervals until the brim starts to crease or break. The units of brim resistance are lb·f-in. Bottom resistance is also a high impact test, but in this case is designed to simulate the energy required to damage the bottom of the cup (e.g., a crease or a crush). The test is conducted by placing a two-cup stack upside down and dropping a weight to strike the cup bottom. Initially, a 2-lb weight at a 2-inch drop (or distance from the cup) is used. The drop distance is increased either 0.5 or 1 inch in each successive test until the bottom of the cup begins to crease or break. The units of bottom resistance are lb·f-in.

Crack resistance, brim crush energy, and sidewall crush energy are low impact tests. Crack resistance is a pass-fail test. A tester places his/her thumb in front of a 16-oz cup and his/her fingers on the opposite side of the cup at a position on the cup which is about two-thirds of the cup height measured from the bottom of the cup. The cup sidewalls are gently squeezed together at a relatively constant rate so that the inside walls touch in about 9 seconds (approximately 20 in/min). If there are no cracks in the sidewall of the cup, the cup passes the crack resistance test. A cup fails if the cup sidewall cracks.

The brim crush energy and sidewall crush energy tests utilize an Instron which is set up horizontally. For the brim crush energy test, plastics bars having a ½-inch square cross-section are loaded into both jaws/grips of the Instron and oriented horizontally. A cup specimen is placed on a table between the plastic bars and held in place during the test. The bars on each side are advanced at 1.5 inch/min to press on the rounded brim of the cup, and push in the brim of the cup until the cup either cracks, breaks, or the inside walls touch. The maximum load is determined in units of lb·f-in. Sidewall crush is determined in a similar manner, except that a ½-inch diameter probe with a rounded tip is placed in both jaws/grips of the Instron and the probes are advanced to press on the sidewall of the cup at a position on the cup which is about two-thirds of the cup height measured from the bottom of the cup. The maximum load is determined in units of lb·f-in.

### EXAMPLE 1

### Comparison of Physical Properties of Polystyrene Grades Filled with up to 35% Calcium Carbonate

Standard ⅛-inch dog bone Type I tensile bars were produced in accordance with ASTM D638 using an Arburg injection molding machine at a temperature of about 400° F. Resins A, C, and D were used in Example 1, having the nominal properties listed in Table I.

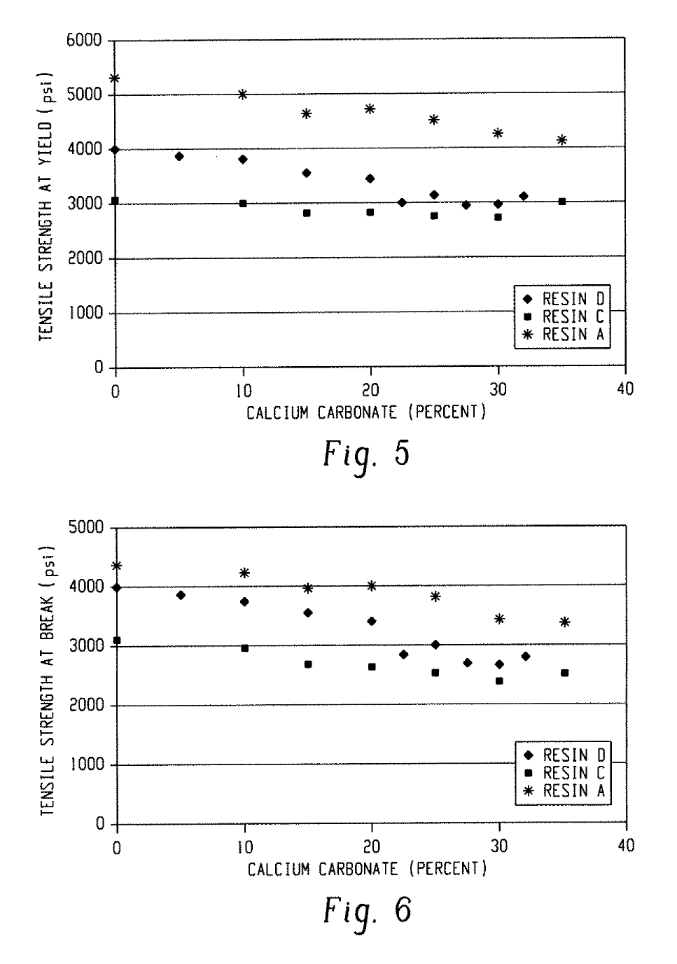

The results of Example 1 are illustrated in FIGS. 5-11. FIG. 5 illustrates that the tensile strength at yield, or yield strength, generally decreases as the weight percent of calcium carbonate increases for all polystyrene grades. Since the test specimens were injection molded samples, results were not obtained for MD and CD. Resin A has a higher flexural modulus and strength, as indicated in Table 1. Not surprisingly, Resin A had the highest yield strength. Resin C and Resin D have equivalent flexural modulus, but Resin D has a lower melt flow rate indicative of a higher molecular weight PS grade. The generally higher yield strength of Resin D across the filler loading levels as compared to that of Resin C may be the result of this difference in molecular weight.

FIG. 6 plots the tensile strength at break as a function of calcium carbonate loading. The same general trends apply in FIG. 6 as shown in FIG. 5. The ultimate tensile strength decreases as the filler loading is increased.

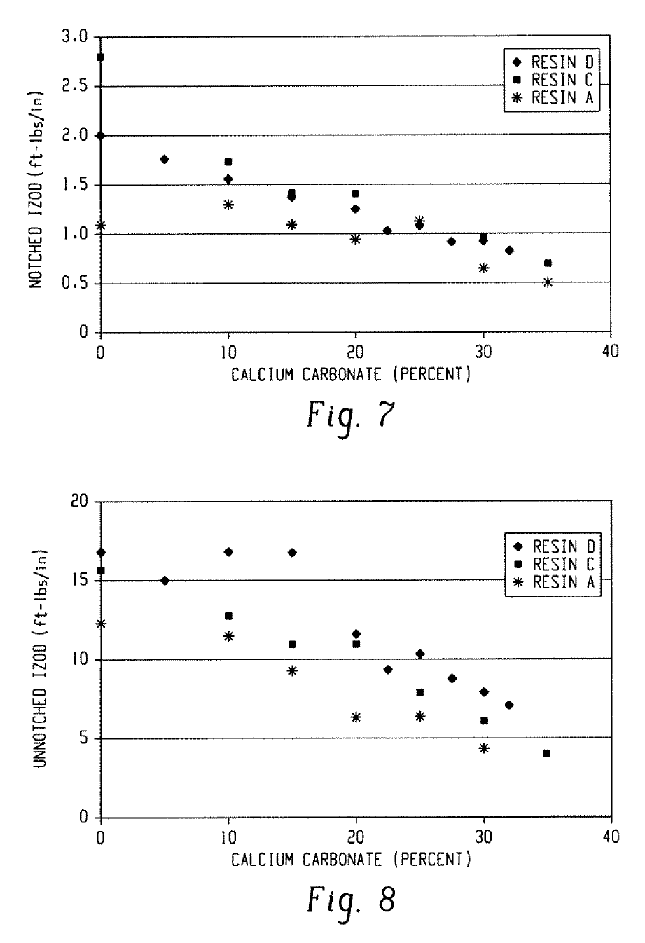

The notched and unnotched Izod impact strengths for the PS grades are illustrated in FIGS. 7 and 8, respectively. These figures further demonstrate that the strength properties of polystyrene (e.g., tensile strength, impact strength) generally deteriorate upon the addition of a filler such as calcium carbonate. Unexpectedly, however, FIGS. 7 and 8 show that HIPS Resins C and D at calcium carbonate levels of 20% or greater have roughly equivalent impact strengths to that of an unfilled HIPS grade, such as Resin A. For instance, the notched impact strength plot illustrates HIPS polymers (Resin C and Resin D) filled with 20-30% calcium carbonate having an impact strength bracketing the impact strength performance of an unfilled HIPS, Resin A (1.1 ft-lbs/in). This is an important and surprising result because it demonstrates that an unfilled PS structure can be replaced with a calcium carbonate filled HIPS structure with no significant deterioration in impact strength. It is also expected that notched impact results tend to correlate with brim resistance testing in multilayer cups, as will be demonstrated below in Examples 18-21. It is generally believed that higher molecular weight (i.e., lower melt flow rate) of the HIPS polymer resin and higher elastomeric material content in the HIPS polymer contribute to improved impact strength.

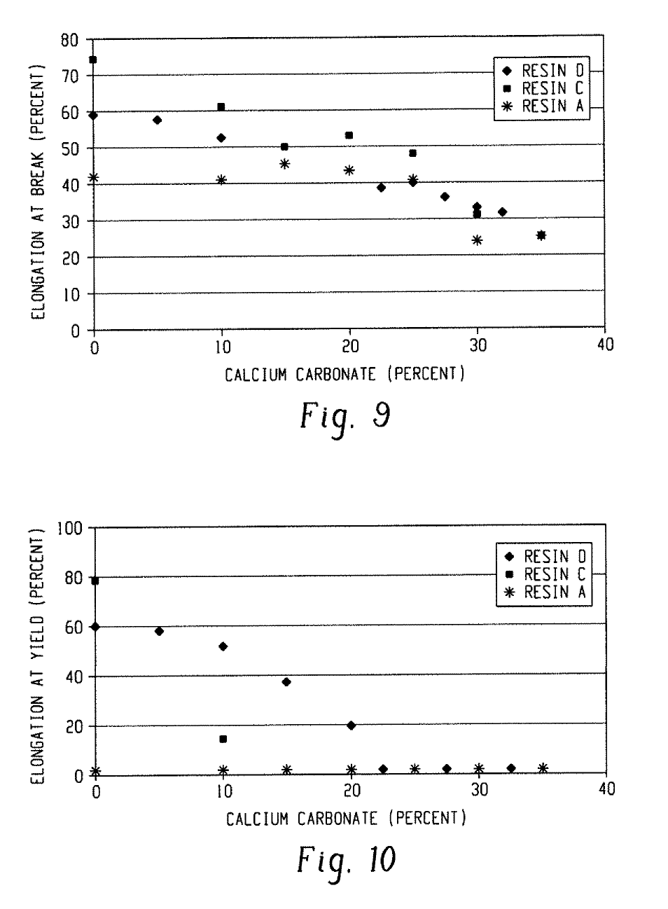

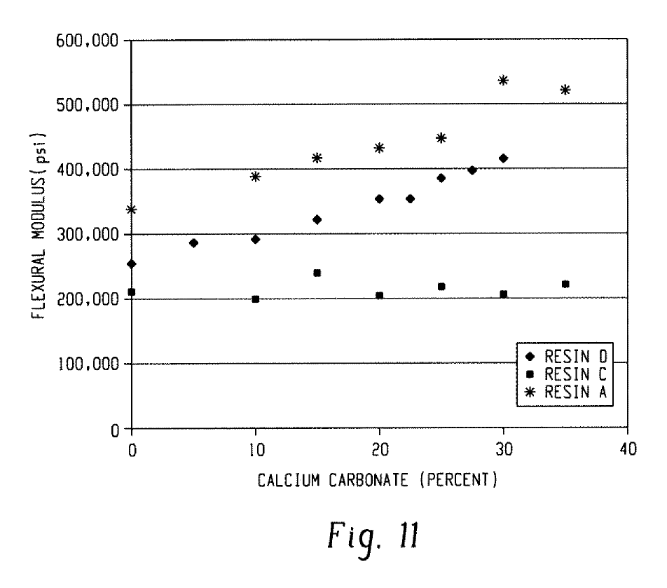

FIGS. 9 and 10 illustrate the elongation at break and the elongation at yield, respectively, as a function of the weight percent of calcium carbonate. Higher elongational properties generally correlate with improved crack resistance and overall toughness, and are influenced by molecular weight (melt flow rate), elastomeric material content, and mineral oil content. The data presented in these figures also demonstrate that HIPS Resins C and D, when filled with 20% and more calcium carbonate, can match the elongational properties of an unfilled HIPS polymer, such as Resin A.

Flexural modulus versus calcium carbonate loading is exemplified in FIG. 11. Flexural modulus is a measure of the rigidity or stiffness of an article or product at a given product weight or thickness. It is an important property for many food service articles, including cups, plates, trays, cutlery, and the like. For HIPS polymers in general, flexural modulus is inversely related to the weight percent of the elastomeric material in the unfilled polymer resin. Polymer molecular weight also impacts flexural modulus.

Filling HIPS polymers with calcium carbonate, however, did not yield predictable results. It was expected that each HIPS resin would have an increase in modulus that correlated with an increase in filler loading. As shown in FIG. 11, Resin A and Resin D followed this roughly linear trend. However, Resin C showed a relatively constant flexural modulus at calcium carbonate loadings of up to 35% weight percent, and never reached the flexural modulus of the unfilled Resin A. Hence, it would be difficult to replace unfilled Resin A with a filled Resin C (even at 20-35% calcium carbonate) and maintain equivalent stiffness and rigidity of a polymer structure.

Interestingly, when Resin D contained calcium carbonate at levels of 20% and greater, the filled Resin D had higher stiffness, as measured by flexural modulus, than the unfilled Resin A (340,000 psi measured in this test). Thus, an article containing unfilled Resin A can be replaced with Resin D filled with 20% or more calcium carbonate and downgauged, or the sheet or wall thickness reduced, to compensate for increased part weight attributed to the addition of the filler, while still maintaining the stiffness and rigidity required for the particular end-use application.

### EXAMPLES 2-13

### Comparison of Physical Properties of Polystyrene Grades Containing a Colorant and 20% Calcium Carbonate

A series of formulations were extruded using a 2″ Welex extruder and a 28″ Cloeren coat-hanger type die at a melt temperature of about 385-400° F. and a monolayer sheet thickness of about 15-20 mils.

Physical properties of the monolayer extruded sheet were measured using large dog bone type samples to test tensile properties such as elongation at break, total energy absorbed or TEA (area under the stress-strain curve as a measure of toughness), and tensile modulus in the machine direction (MD) as a measure of stiffness. Taber Stiffness was also measured from extruded sheet samples. For Examples 2-13, Table II lists the blended formulations and Table III presents the physical properties.

TABLE II
Formulations of Examples 2-13.

| | | | | | Color | | CaCO₃ |
|---|---|---|---|---|---|---|---|
| | Total | | Resin | | Conc. | | Conc. |
| Example | Wt. | PS | Wt. | Color | Wt. | CaCO₃ | Wt. |
| Number | (lbs.) | Resin | (lbs.) | Conc. | (lbs.) | Conc. | (lbs.) |
| 2 | 100 | B | 100 | | | | |
| 3 | 100 | A | 100 | | | | |
| 4 | 100 | D | 100 | | | | |
| 5 | 100 | B | 98 | W1 | 2 | | |
| 6 | 100 | B | 97.8 | W2 | 2.2 | | |
| 7 | 100 | B | 98.1 | W3 | 1.9 | | |
| 8 | 100 | A | 98 | W1 | 2 | | |
| 9 | 100 | A | 97.8 | W2 | 2.2 | | |
| 10 | 100 | A | 98.1 | W3 | 1.9 | | |
| 11 | 100 | D | 71.3 | W1 | 2.0 | Ca1 | 26.7 |
| 12 | 100 | D | 71.1 | W2 | 2.2 | Ca1 | 26.7 |
| 13 | 100 | D | 71.4 | W3 | 1.9 | Ca1 | 26.7 |

Notes for Table II:
W1 - Color concentrate or masterbatch containing approximately 58% TiO₂ in a crystal PS carrier resin with a melt flow rate of 7.
W2 - Color concentrate or masterbatch containing approximately 52% TiO₂ in a HIPS carrier resin with a melt flow rate of 14.
W3 - Color concentrate or masterbatch containing approximately 65% TiO₂ in a linear low density polyethylene carrier resin (LLDPE) with a melt index of 2.
Ca1 - Calcium carbonate concentrate or masterbatch containing approximately 75% CaCO₃ in a Resin E carrier.

TABLE III
Physical Properties of Examples 2-13.

| | Taber | Tensile | Elongation | |
|---|---|---|---|---|
| | Stiffness | Modulus | at break | TEA |
| Example | (g cm) | (psi × 1000) | (%) | (lb-in/in²) |
| Number | (MD) | (MD) | (MD) | (MD) |
| Resins Alone | | | | |
| 2 | 54.4 | 322.2 | 1.38 | 9.87 |
| 3 | 63.1 | 352.3 | 1.82 | 18.63 |
| 4 | 57.1 | 288.2 | 45.53 | 33.63 |
| Resin + Colorant | | | | |
| 5 | 51.1 | 323.4 | 1.31 | 14.16 |
| 6 | 54.3 | 332.4 | 1.31 | 16.29 |
| 7 | 50.5 | 329.7 | 1.32 | 16.27 |
| 8 | 66.8 | 368.8 | 1.98 | 10.36 |
| 9 | 69.0 | 362.2 | 2.06 | 14.19 |
| 10 | 43.6 | 397.8 | 2.29 | 12.48 |
| Resin + Colorant + | | | | |
| Calcium Carbonate | | | | |
| 11 | 51.5 | 409.4 | 39.09 | 24.38 |
| 12 | 45.6 | 390.8 | 38.15 | 21.45 |
| 13 | 42.4 | 388.4 | 37.77 | 20.69 |

Examples 5-7 contain Resin B with TiO₂ colorant in three different carrier resins—a crystal PS polymer, a HIPS polymer, and a LLDPE polymer. Similarly, Examples 8-10 contain Resin A with TiO₂ colorant in the same three carrier resins. Examples 11-13 contain Resin D with TiO₂ colorant in these carrier resins as well as 20% calcium carbonate. The data in Table III indicates that Examples 11-13 generally have higher stiffness, as measured by tensile modulus, than the unfilled (without calcium carbonate) formulations containing Resin A or Resin B. The Taber stiffness shows slightly lower stiffness values for Examples 11-13 containing Resin D. The combination of stiffness measurements is not entirely conclusive. However, the combined data does indicate that the relative stiffness of filled Resin D is comparable to that of unfilled Resin A and Resin B, when all materials also contain a TiO₂ colorant additive.

According to Table III, the impact and strength properties, namely elongation and TEA, are dramatically improved for Examples 11-13 as compared to those of Examples 5-10, at relatively equivalent stiffness values. The improvement in elongation is at least one order of magnitude, while the improvement in TEA is, on average, approximately 60%. Thus, an article containing unfilled Resin A or Resin B can be replaced with Resin D filled with 20% calcium carbonate, maintaining equivalent rigidity, yet with a significant and unexpected improvement in strength properties.

### EXAMPLES 14-17

### Unsuccessful Multilayer Cup Experiments Utilizing Resin A and Greater than 20% Calcium Carbonate

A series of muitilayer structures were produced using a conventional configuration of multiple single screw extruders followed by a combining block and a melt pump to feed the die in order to produce multilayer sheet at a thickness of about 50-55 mils. Extruder barrel and melt pump temperatures were maintained in the 350-450° F. range, and the die temperatures were set at approximately 400° F. The resulting sheet was fed into a Brown 100-cavity thermoforming machine to produce 16-oz multilayer cups. Tables IV and V show the structures and formulations for Example 14 and for Examples 15-17, respectively. Regrind of each respective multilayer structure was fed back into the core layer at the percentages listed.

TABLE IV
Formulation of Example 14.

| | % of total | |
|---|---|---|
| Layer | thickness | Composition |
| Inner | 20% | 97.6% Resin A; 2.4% W2 TiO₂ masterbatch |
| Core | 68% | 35% Resin A; 65% Regrind |
| Outer | 10% | 98.8% Resin A; 1.2% Red masterbatch |
| Cap | 2% | 100% crystal PS grade with melt flow of 9 |

TABLE V
Formulation of Examples 15-17.

| | % of total | |
|---|---|---|
| Layer | thickness | Composition |
| Inner | 20% | 61.9% Resin A; 2.4% W2 TiO₂ masterbatch; |
| | | 35.7% CaCO₃ masterbatch |
| Core | 68% | 22.5% Resin A; 65% Regrind; |
| | | 12.5% CaCO₃ masterbatch |
| Outer | 10% | 63.8% Resin A; 1.2% Red masterbatch |
| | | 35% CaCO₃ masterbatch |
| Cap | 2% | 100% crystal PS grade with melt flow of 9 |

Notes for Tables IV and V:
Red masterbatch - Red color concentrate or masterbatch in a crystal PS carrier resin with a melt flow rate of 14.
CaCO₃ masterbatch - Masterbatch containing approximately 70% CaCO₃ in a Resin B carrier.

Table VI compares the cup properties of multilayer structures produced with and without calcium carbonate. Example 14 contained no calcium carbonate, while Examples 15-17 each contained about 25% calcium carbonate in all layers except the cap layer. Resin A was the virgin resin employed in each of these examples. As can be seen from the data in Table VI, there was generally an increase in the rigidity of the cups of Examples 15-17 due to the presence of the calcium carbonate, as measured by the dry rigidity test. It is expected that this increase in rigidity would have been even higher had the cup weights been the same for all of the examples. However, Table VI also shows a dramatic reduction in the brim resistance and bottom resistance of the filled multilayer cups of Examples 15-17. Although there is a 6-8% difference in cup weight for Examples 15-17 versus Example 14, such a difference cannot explain the increase in cup brittleness evidenced by an average drop in the brim resistance of about 50% and in the bottom resistance of about 17%. In sum, simply taking an existing structure that produces acceptable multilayer cups (Example 14, using Resin A) and adding 20% or more calcium carbonate to that structure, with no changes to the grade of virgin HIPS polymer or otherwise, will not yield a commercially viable product.

TABLE VI
Multilayer Cup Properties of Examples 14-17.

Example Number

| | 14 | 15 | 16 | 17 |
|---|---|---|---|---|
| CaCO₃ (%) | 0% | 24.5% | 24.5% | 24.5% |
| Cup Weight (g) | 14.37 | 13.25 | 13.59 | 13.53 |
| Dry Rigidity (lb.f) | 0.837 | 0.83 | 0.886 | 1.008 |
| Brim Resistance | 9.5 | 3.5 | 5.3 | 4.80 |
| (lb.f-in.) | | | | |
| Bottom | 13.4 | 11.3 | 10.6 | 11.3 |
| Resistance | | | | |
| (lb.f-in.) | | | | |
| Sample Size | 10 | 10 | 10 | 10 |

### EXAMPLES 18-24

### Inventive Multilayer Cup Experiments Utilizing Resin E and 20% or More Calcium Carbonate

A series of multilayer structures were produced using a conventional configuration of multiple single screw extruders followed by a combining block and a melt pump to feed the die to in order to produce multilayer sheet at a thickness of about 50-55 mils. Extruder barrel and melt pump temperatures were maintained in the 350-450° F. range, and the die temperatures were set at approximately 400° F. The resulting sheet was fed into a Brown 100-cavity thermoforming machine to produce 16-oz multilayer cups. Tables VII, VIII, and IX list the structures and formulations, respectively, for Example 18, Example 19, and Examples 20-21. Regrind of each respective multilayer structure was fed back into the core layer at the percentages listed. Examples 22-24 were produced with the structure and formulation shown below for Examples 20-21, with the exception that the ratio of Resin E to CaCO₃ masterbatch in the core layer blend was varied to derive overall calcium carbonate loadings of about 24.7% (Example 22), about 27.4% (Example 23), and about 28.2% (Example 24).

TABLE VII
Formulation of Example 18.

| | % of total | |
|---|---|---|
| Layer | thickness | Composition |
| Inner | 20% | 97.6% Resin A; 2.4% W2 TiO₂ masterbatch |
| Core | 68% | 35% Resin A; 65% Regrind |
| Outer | 10% | 98.8% Resin A; 1.2% Red masterbatch |
| Cap | 2% | 100% crystal PS grade with melt flow of 9 |

TABLE VIII
Formulation of Example 19.

| | % of total | |
|---|---|---|
| Layer | thickness | Composition |
| Inner | 20% | 97.6% Resin A; 2.4% W2 TiO₂ masterbatch |
| Core | 68% | 23% Resin A; 65% Regrind; |
| | | 12% CaCO₃ masterbatch |
| Outer | 10% | 98.8% Resin A; 1.2% Red masterbatch |
| Cap | 2% | 100% crystal PS grade with melt flow of 9 |

TABLE IX
Formulation of Examples 20-21.

| | % of total | |
|---|---|---|
| Layer | thickness | Composition |
| inner | 20% | 97.6% Resin E; 2.4% W2 TiO₂ masterbatch |
| Core | 68% | 13.1% Resin E; 65% Regrind; |
| | | 21.9% CaCO₃ masterbatch |
| Outer | 10% | 98.8% Resin E; 1.2% Red masterbatch |
| Cap | 2% | 100% crystal PS grade with melt flow of 9 |

Notes for Tables VII, VIII, and IX:
Red masterbatch - Red color concentrate or masterbatch in a crystal PS carrier resin with a melt flow rate of 14.
CaCO₃ masterbatch - Masterbatch containing approximately 75% CaCO₃ in a Resin E carrier.

Table X compares the cup properties of the multilayer structures of Examples 18-24. Example 18 serves as the control, using Resin A in a standard, commercially available structure and formulation, containing no calcium carbonate filler. Example 18 is representative of the currently acceptable multilayer cup in the marketplace.

Example 19 contained Resin A and 11% calcium carbonate, and showed improved brim resistance, bottom resistance, brim crush, and sidewall crush versus Example 18. However, Example 19 did not pass the crack resistance test, likely indicating that cups produced using this formulation were too stiff and/or brittle. Additionally, as demonstrated in Examples 14-17 and FIGS. 7-10, Resin A cannot be filled with over 20% filler without a significant decrease in strength and impact properties.

Examples 20 and 21 employed Resin E with 20% calcium carbonate and each example showed an unexpected combination of stiffness/rigidity and toughness/strength. The dry rigidity cup data in Table X shows a large improvement in the stiffness of the cups of Examples 20 and 21 due to the presence of the calcium carbonate, as compared to the unfilled control of Example 18. The rigidity of the cups of Examples 20 and 21 were also on par with the rigidity of the cups of Example 19, which contained Resin A and 11% calcium carbonate. The brim resistance and bottom resistance results, which are high impact tests, for Examples 20 and 21 were even more surprising. First, it should be noted that Examples 20 and 21, due to the presence of 20% of the higher density calcium carbonate, were about 9.5% heavier in product weight. Calcium carbonate has a density of approximately 2.8 g/cc, compared to a HIPS polymer resin density of around 1 to 1.05. However, the sidewall thicknesses of the cups of Examples 20-21, measured at comparable locations, were approximately 10% thinner than the sidewall thicknesses of the cups of Example 18. Hence, the weight increased, but the thickness was decreased to mitigate some of the weight increase due to the presence of the higher specific gravity filler, calcium carbonate.

As compared with Example 18, the cups of Examples 20 and 21 showed an average increase in brim resistance of approximately 80%. Likewise, the cups of Examples 20 and 21 showed an average increase in bottom resistance of approximately 80% versus those of Example 18. Similarly, the cups of Examples 20 and 21 performed much better than those of Example 18 in the crack resistance, brim crush, and sidewall crush tests, indicating superior toughness and end-use performance.

Thus, an article, such an a multilayer cup, containing unfilled Resin A can be replaced with Resin E filled with 20% calcium carbonate with an unexpected combination of increased rigidity or stiffness plus improved impact, strength, and crack resistance properties. Further, this can be accomplished in a downgauged structure.

Examples 22-24 utilized Resin E and contained calcium carbonate in the 24-28 weight percent range. As with Examples 20-21, the dry rigidity cup data in Table X showed improvement in the stiffness/rigidity of the cups of Examples 22-24 as compared to the unfilled control of Example 18. To mitigate some of the weight increase due to calcium carbonate, the cups of Examples 22-24 were downgauged. The sidewall thicknesses of the cups of Examples 22-24, measured at comparable locations, were at least 10% thinner than the sidewall thicknesses of the cups of Example 18.

High impact tests were not conducted on Examples 22-24. However, the cups of Examples 22-24 all passed the crack resistance test. The brim crush of Examples 22-24 was on par with that of Example 18, while each of Examples 22-24 showed superior sidewall crush results. Thus, higher loadings of calcium carbonate can be employed in a cup formulation, while still maintaining an acceptable balance of stiffness/rigidity, impact/toughness, and overall end-use performance.

TABLE X
Multilayer Cup Properties of Examples 18-24.

| | Example Number | | | | | | |
|---|---|---|---|---|---|---|---|
| | 18 | 19 | 20 | 21 | 22 | 23 | 24 |
| CaCO₃ (%) | 0% | 11% | 20.0% | 20.0% | 24.7% | 27.4% | 28.2% |
| Cup Weight (g) | 12.43 | 13.58 | 13.70 | 13.53 | 13.07 | 13.14 | 13.07 |
| Dry Rigidity (lb.f) | 0.58 | 0.81 | 0.78 | 0.77 | 0.68 | 0.71 | 0.69 |
| Brim Resistance | 7.4 | 10.1 | 14.4 | 12.2 | N/A | N/A | N/A |
| (lb.f-in.) | | | | | | | |
| Bottom Resistance | 5.8 | 9.2 | 10.6 | 10.8 | N/A | N/A | N/A |
| (lb.f-in.) | | | | | | | |
| Crack Resistance Test | Fail | Fail | Pass | Pass | Pass | Pass | Pass |
| Brim Crush Energy | 4.72 | 9.25 | 7.74 | 6.40 | 4.51 | 5.25 | 5.02 |
| (lb.f-in.) | | | | | | | |
| Sidewall Crush Energy | 0.60 | 0.80 | 0.77 | 0.81 | 0.73 | 0.68 | 0.69 |
| (lb.f-in.) | | | | | | | |
| Sample Size | 10 | 10 | 10 | 10 | 10 | 10 | 10 |

### EXAMPLES 25-41

### Comparison of Physical Properties of Polystyrene Grades Containing a Colorant and 15-35% Calcium Carbonate

Examples 25-41 were produced in accordance with the procedure outlined in Examples 2-13. For Examples 25-41, Table XI lists the blended formulations and Table XII presents the physical properties. Examples 2-3, 5, and 8 are reproduced in these tables for ease of comparison.

TABLE XI
Formulations of Examples 2-3, 5, 8, and 25-41

| | | | | | Color | | CaCO₃ |
|---|---|---|---|---|---|---|---|
| | Total | | Resin | | Conc. | | Conc. |
| Example | Wt. | PS | Wt. | Color | Wt. | CaCO₃ | Wt. |
| Number | (lbs.) | Resin | (lbs.) | Conc. | (lbs.) | Conc. | (lbs.) |
| 2 | 100 | B | 100 | | | | |
| 3 | 100 | A | 100 | | | | |
| 5 | 100 | B | 98 | W1 | 2 | | |
| 8 | 100 | A | 98 | W1 | 2 | | |
| 25 | 100 | F | 97.94 | W1 | 2.06 | | |
| 26 | 100 | G | 97.94 | W1 | 2.06 | | |
| 27 | 100 | H | 97.94 | W1 | 2.06 | | |
| 28 | 100 | I | 97.94 | W1 | 2.06 | | |
| 29 | 100 | G | 77.94 | W1 | 2.06 | Ca1 | 20 |
| 30 | 100 | H | 77.94 | W1 | 2.06 | Ca1 | 20 |
| 31 | 100 | I | 77.94 | W1 | 2.06 | Ca1 | 20 |
| 32 | 100 | F | 71.27 | W1 | 2.06 | Ca1 | 26.67 |
| 33 | 100 | G | 71.27 | W1 | 2.06 | Ca1 | 26.67 |
| 34 | 100 | H | 71.27 | W1 | 2.06 | Ca1 | 26.67 |
| 35 | 100 | I | 71.27 | W1 | 2.06 | Ca1 | 26.67 |
| 36 | 100 | F | 64.61 | W1 | 2.06 | Ca1 | 33.33 |
| 37 | 100 | G | 64.61 | W1 | 2.06 | Ca1 | 33.33 |
| 38 | 100 | H | 64.61 | W1 | 2.06 | Ca1 | 33.33 |
| 39 | 100 | I | 64.61 | W1 | 2.06 | Ca1 | 33.33 |
| 40 | 100 | I | 57.94 | W1 | 2.06 | Ca1 | 40 |
| 41 | 100 | I | 51.27 | W1 | 2.06 | Ca1 | 46.67 |

Notes for Table XI:
W1 - Color concentrate or masterbatch containing approximately 58% TiO₂ in a crystal PS carrier resin with a melt flow rate of 7.
Ca1 - Calcium carbonate concentrate or masterbatch containing approximately 75% CaCO₃ in a Resin E carrier.

TABLE XII
Physical Properties of Examples 2-3, 5, 8, and 25-41.

| | Taber | Tensile | Elongation | |
|---|---|---|---|---|
| | Stiffness | Modulus | at break | TEA |
| Example | (g cm) | (psi × 1000) | (%) | (lb-in/in²) |
| Number | (MD) | (MD) | (MD) | (MD) |
| Resins Alone | | | | |
| 2 | 54.4 | 322.2 | 1.38 | 9.87 |
| 3 | 63.1 | 352.3 | 1.82 | 18.63 |
| Resin + Colorant | | | | |
| 5 | 51.1 | 323.4 | 1.31 | 14.16 |
| 8 | 66.8 | 368.8 | 1.98 | 10.36 |
| 25 | 57.6 | 329.6 | 41.36 | 28.11 |
| 26 | 30.2 | 242.7 | 59.30 | 33.44 |
| 27 | 30.5 | 280.6 | 42.14 | 31.57 |
| 28 | 45.2 | 243.6 | 60.31 | 40.93 |
| Resin + Colorant + | | | | |
| 15% Calcium | | | | |
| Carbonate | | | | |
| 29 | 27.5 | 326.0 | 38.33 | 21.24 |
| 30 | 31.0 | 320.3 | 46.27 | 22.54 |
| 31 | 35.6 | 284.1 | 62.07 | 31.39 |
| Resin + Colorant + | | | | |
| 20% Calcium | | | | |
| Carbonate | | | | |
| 32 | 46.5 | 443.4 | 44.10 | 27.46 |
| 33 | 27.1 | 346.8 | 40.98 | 21.62 |
| 34 | 28.2 | 353.6 | 39.82 | 22.93 |
| 35 | 40.9 | 319.0 | 61.07 | 23.66 |
| Resin + Colorant + | | | | |
| 25% Calcium | | | | |
| Carbonate | | | | |
| 36 | 46.0 | 484.2 | 36.31 | 17.53 |
| 37 | 25.1 | 337.0 | 44.87 | 18.73 |
| 38 | 27.8 | 384.0 | 34.23 | 17.43 |
| 39 | 36.9 | 345.2 | 47.30 | 19.45 |
| Resin + Colorant + | | | | |
| 30% and 35% | | | | |
| Calcium | | | | |
| Carbonate | | | | |
| 40 | 34.6 | 396.2 | 40.79 | 14.94 |
| 41 | 36.0 | 451.2 | 32.68 | 9.21 |

Examples 5 and 8 contain Resins B and A, respectively, with a TiO₂ colorant. Examples 32-35 contain Resins F-I, respectively, with a TiO₂ colorant and 20% calcium carbonate. Examples 36-39 contain Resins F-I, respectively, with a TiO₂ colorant and 25% calcium carbonate. The data in Table XII indicates that Examples 32-35 (with 20% calcium carbonate) and Examples 36-39 (with 25% calcium carbonate) generally have similar stiffness, as measured by tensile modulus, to the unfilled (without calcium carbonate) formulations containing Resin A or Resin B (Examples 5 and 8). The Taber stiffness shows lower stiffness values for Examples 32-39.

According to Table XII, the impact and strength properties, namely elongation at break and TEA, are dramatically improved for Examples 32-39 as compared to those of Examples 5 and 8, at relatively equivalent modulus/stiffness values. The improvement in elongation is at least one order of magnitude, while the improvement in TEA is, on average, approximately 90% for the examples with 20% calcium carbonate and approximately 45% for the examples with 25% calcium carbonate. Thus, an article containing unfilled Resin A or Resin B can be replaced with Resins F-I filled with 20-25% calcium carbonate, maintaining relatively equivalent rigidity as measured by modulus, yet with a significant and unexpected improvement in strength properties.

Examples 40-41 containing 30% and 35% calcium carbonate, respectively, demonstrate that higher loadings of calcium carbonate are achievable, while maintaining an acceptable balance of stiffness/rigidity and impact/toughness.

We claim:

1. A multilayer polymer structure comprising:
(a) a core layer having a first side and a second side, the core layer comprising at least one filler;
(b) an inner layer positioned on the first side of the core layer;
(c) an outer layer positioned on the second side of the core layer;
wherein:
the multilayer composite polymer structure comprises from 20 to about 40 weight percent of the at least one filler; and
each of the core layer, the inner layer, and the outer layer, independently, comprise at least one high impact polystyrene (HIPS) polymer,
wherein the at least one HIPS polymer has an elastomeric material content of at least about 7 percent by weight, an average particle size of the elastomeric material from about 1 to about 10 microns, a mineral oil content of less than about 4 percent by weight, and
wherein the at least one HIPS polymer is characterized by a melt flow rate of less than about 12 and a flexural modulus from about 200,000 to about 400,000 psi.

2. The polymer structure of claim 1, wherein the at least one filler is calcium carbonate.

3. The polymer structure of claim 1, wherein the weight percent of the at least one filler in the multilayer polymer structure is from 20 percent to about 30 percent.

4. The polymer structure of claim 1, wherein the polymer structure further comprises crystal polystyrene, and wherein the weight percent of the crystal polystyrene in the polymer structure is less than 5 percent.

5. The polymer structure of claim 1, wherein the melt flow rate of the HIPS polymer is from about 2.8 to about 3.5

6. The polymer structure of claim 1, wherein the elastomeric material content of the HIPS polymer is from about 7 to about 10.5 percent by weight.

7. The polymer structure of claim 1, wherein the average particle size of the elastomeric material is from about 2 to about 8 microns.

8. The polymer structure of claim 1, wherein the HIPS polymer is further characterized by a flexural modulus from about 225,000 to about 325,000 psi.

9. The polymer structure of claim 1, wherein the weight percent of the elastomeric material in the polymer structure is from about 4 percent to about 9 percent.

10. A food service article made from the polymer structure of claim 1.

11. A masterbatch composition comprising:
(a) at least one high impact polystyrene (HIPS) polymer; and
(b) at least one filler;
wherein:
the masterbatch composition comprises from about 50 to about 85 weight percent of the at least one filler; and
the at least one HIPS polymer has an elastomeric material content of at least about 7 percent by weight, an average particle size of the elastomeric material from about 1 to about 10 microns, a mineral oil content of less than about 4 percent by weight, and
wherein the at least one HIPS polymer is characterized by a melt flow rate of less than about 12 and a flexural modulus from about 200,000 to about 400,000 psi.

12. The composition of claim 11, wherein the at least one filler is calcium carbonate.

13. The composition of claim 11, wherein the weight percent of the at least one filler in the masterbatch is from about 70 percent to about 80 percent.

14. A single layer polymer structure comprising the composition of claim 11.

15. A multilayer polymer structure comprising at least one layer which comprises the composition of claim 11.

16. A method of making a multilayer polymer structure comprising:
(a) providing a core layer, an inner layer, and an outer layer,
wherein:
the core layer comprises at least one high impact polystyrene polymer and from about 25 to about 50 weight percent of at least one filler having a density of greater than about 2 g/cc;
each of the inner layer and the outer layer, independently, comprise at least one high impact polystyrene (HIPS) polymer,
wherein the at least one HIPS polymer has an elastomeric material content of at least about 7 percent by weight, an average particle size of the elastomeric material from about 1 to about 10 microns, a mineral oil content of less than about 4 percent by weight, and
wherein the at least one HIPS polymer is characterized by a melt flow rate of less than about 12 and a flexural modulus from about 200,000 to about 400,000 psi; and
(b) coextruding the core layer between the inner layer and the outer layer to produce the multilayer polymer structure,
wherein the multilayer polymer structure comprises from 20 to about 40 weight percent of the at least one filler.

17. The method of claim 16, wherein the at least one filler is calcium carbonate.

18. The method of claim 16, wherein the multilayer polymer structure further comprises crystal polystyrene, and wherein the weight percent of the crystal polystyrene in the polymer structure is less than 5 percent.

19. The method of claim 16, wherein the weight percent of the elastomeric material in the multilayer polymer structure is from about 4 percent to about 9 percent.

20. The method of claim 16, wherein the weight percent of the at least one filler in the core layer is from about 25 percent to about 40 percent.

21. The method of claim 16, wherein the method further comprises a step of forming the multilayer polymer structure into a food service article.

22. A multilayer food service article comprising
(a) a core layer having a first side and a second side, the core layer comprising at least one filler;
(b) an inner layer adjacent to the first side of the core layer;
(c) an outer layer adjacent to the second side of the core layer;
wherein:
the multilayer food service article comprises from 20 to about 40 weight percent of the at least one filler; and
each of the core layer, the inner layer, and the outer layer, independently, comprise at least one high impact polystyrene (HIPS) polymer,
wherein the at least one HIPS polymer has an elastomeric material content of at least about 7 percent by weight, an average particle size of the elastomeric material from about 1 to about 10 microns, a mineral oil content of less than about 4 percent by weight, and
wherein the at least one HIPS polymer is characterized by a melt flow rate of less than about 12 and a flexural modulus from about 200,000 to about 400,000 psi.

23. The article of claim 22, wherein the at least one filler is calcium carbonate.

24. The article of claim 22, wherein the elastomeric material content of the HIPS polymer is from about 7 to about 10.5 percent by weight and the melt flow rate of the HIPS polymer is less than about 3.6.

25. A multilayer cup comprising:
(a) a core layer having a first side and a second side, the core layer comprising calcium carbonate;
(b) an inner layer adjacent to the first side of the core layer;
(c) an outer layer adjacent to the second side of the core layer;
(d) a cap layer adjacent to the outer layer, the cap layer comprising crystal polystyrene;
wherein:
each of the core layer, the inner layer, and the outer layer, independently, comprise at least one high impact polystyrene (HIPS) polymer;
the at least one HIPS polymer has an elastomeric material content from about 7 percent to about 10.5 percent by weight, an average particle size of the elastomeric material from about 2 to about 8 microns, a mineral oil content of less than about 4 percent by weight;
the at least one HIPS polymer is characterized by a melt flow rate of less than about 3.6 and a flexural modulus from about 225,000 to about 325,000 psi; and
the multilayer cup comprises from 20 to about 40 weight percent of calcium carbonate, from about 4 to about 9 weight percent of elastomeric material, and less than 5 weight percent crystal polystyrene.
